(19) United States
(12) Patent Application Publication
(10) Pub. No.: US 2005/0263396 A1
(43) Pub. Date: Dec. 1, 2005

(54) Gas sensing element and its manufacturing method

(75) Inventors: Susumu Naito, Kariya-shi (JP); Akio Tanaka, Gifu-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/135,508

(22) Filed: May 24, 2005

(30) Foreign Application Priority Data
May 25, 2004 (JP) 2004-154529
Feb. 9, 2005 (JP) 2005-033159

(51) Int. Cl. G01N 27/26

(52) U.S. Cl. 204/424; 29/592.1

(57) ABSTRACT

A multilayered gas sensing element includes a solid electrolytic substrate. A measured gas side electrode and a reference electrode are provided on surfaces of the solid electrolytic substrate. The measured gas side electrode is provided in a measured gas chamber. An introducing hole forming layer has an introducing hole for introducing a measured gas from an ambient atmosphere into the measured gas chamber and also providing a diffusion resistance to the measured gas introduced into the measured gas chamber. In manufacturing this gas sensing element, the introducing hole is formed by performing laser irradiation applied to the introducing hole forming layer.

### CROSS-REFERENCE TO RELATED APPLICATION

This application is based upon and claims the benefit of priority from earlier Japanese Patent Application No. 2004-154529 filed on May 25, 2004 and the Japanese Patent Application No. 2005-33159 filed on Feb. 9, 2005 so that the descriptions of which are incorporated herein by reference.

### BACKGROUND OF THE INVENTION

The present invention relates to a gas sensing element used for the combustion control of an automotive internal combustion engine or the like, and also relates to its manufacturing method.

To detect an air-fuel ratio of fuel mixture based on an oxygen concentration in the exhaust gas and also to perform a combustion control of an automotive internal combustion engine with reference to the detected air-fuel ratio, it is conventionally known in an exhaust gas feedback system to provide an A/F sensor or a comparable gas sensor in an exhaust device of this engine. Especially, to efficiently purify the exhaust gas with a ternary catalyst, it is important to control the air-fuel ratio of the fuel mixture in an engine combustion chamber to a specific value. For example, an oxygen sensor detecting the oxygen concentration and its variation in the exhaust gas can be used as a gas sensor for the above-described exhaust gas feedback system. Furthermore, a NOx sensor detecting a NOx (i.e. one of the air pollution substances) concentration in the exhaust gas can be also used as a gas sensor for the above-described exhaust gas feedback system. For example, these gas sensors include zirconia solid electrolytic substrates or the like to arrange an A/F sensing element, an oxygen sensing element, a NOx sensing element, or the like for detection of intended gas concentrations. The Japanese patent application laid-open No. 12-065782 shows a representative arrangement of these gas sensing elements.

FIG. 20 shows a general gas sensing element which includes a solid electrolytic substrate 11, a measured gas side electrode 21 and a reference electrode 22 provided on surfaces of the solid electrolytic substrate 11, and a measured gas chamber in which the measured gas side electrode 21 is provided. The measured gas chamber consists of window portions 910 and 920 provided in an insulating layer 91 and a spacer 92 laminated on the solid electrolytic substrate 11. A porous layer 93 defines a ceiling of the measured gas chamber. A dense layer 94 is laminated on the porous layer 93. A measured gas is introduced from the outside of the element into the measured gas chamber. The porous layer 93 disposed between the ambient atmosphere and the measured gas chamber gives a diffusion resistance to the measured gas introduced into the measured gas chamber.

When an appropriate voltage is applied between the measured gas side electrode and the reference electrode, a specific gas decomposes on the measured gas side electrode and produces oxygen ions. Under the condition that the voltage is applied between the electrodes, the oxygen ions shift toward the reference electrode and accordingly the current flows between both electrodes. Usually, the current value increases in proportion to the applied voltage. According to the gas sensing element having a diffusion resistance, the flow rate of the measured gas introduced from the outside is substantially determined by the diffusion resistance. This causes a region where the current does not substantially increase irrespective of increasing voltage. The current value in this region is referred to as a limiting current value. The limiting current value is proportional to a specific gas concentration in the measured gas. Thus, measuring the limiting current value appearing when an appropriate voltage is applied between the measured gas side electrode and the reference electrode makes it possible to detect the specific gas concentration.

The gas sensing element incorporated in the gas sensor is required to be prompt in activation and high in detection accuracy when used in the above-described exhaust gas feedback system. Especially, regarding the detection accuracy, it is usually required to have sensor performance capable of accurately detecting the gas concentration in a turbo system or in a diesel engine system in which the exhaust gas causes large temperature variations and pressure variations.

In general, the detection accuracy of this sensing element depends on temperature variations and pressure variations. The degree of dependency is determined by the contribution of diffusion patterns, for example between Knudsen diffusion and molecular diffusion in a case that the exhaust gas (i.e. a measured gas) diffuses in a diffusion resistance portion of the gas sensing element, as reported in the preliminary printed article 842054 of annual congress, by the society of automotive engineers in Japan. In general, the contribution of diffusion patterns is chiefly dependent on the pore diameter of the diffusion resistance portion, and accordingly the temperature variations and the pressure variations are in the trade-off relationship. It is therefore difficult to reduce both of the influences of temperature variations and pressure variations by modifying the diffusion structure of the gas sensing element. Thus, optimizing the balance between temperature variations and pressure variations is usually managed in the designing stage with reference to market requirements.

For example, if the diffusion resistance portion is required to have a pore diameter equal to or less than 1 μm, a porous layer having higher porosity will be preferably used to arrange the diffusion resistance portion. If the diffusion resistance portion is required to have a pore diameter equal to or greater than 70 μm, a pinhole (i.e. an introducing hole) will be preferably used to arrange the diffusion resistance portion. Regarding the diffusion resistance portion having a pore diameter somewhere between 1 μm and 70 μm, it will be preferable to use a slit arrangement as shown in the Japanese patent application laid-open No. 2000-28576. It is also possible to adjust the contributions of the Knudsen diffusion and the molecular diffusion by appropriately combining two diffusion resistance portions (i.e. the pinhole and the porous layer), so that the detection accuracy of a gas sensing element depends on both the temperature variations and the pressure variations with good balance.

However, according to the method using a slit arrangement or the method combining the porous layer and the pinhole, gas sensing elements tend to have manufacturing differences in the output characteristics. Regarding the output differences, it is possible to employ an external adjustment using an adjusting resistance (refer to the Japanese Utility Model No. 7-27391). It is also possible to employ appropriate grinding processing applied to a completed gas sensing element so as to change the diffusion resistances (refer to the Japanese patent application laid-open No. 2001-153835). However, regarding the pore diameter, it is difficult to modify the slit structure after the gas sensing element is completed. From this reason, adjusting the output characteristics at a later timing is difficult in a case that the gas sensing element employs a slit arrangement.

Furthermore, according to a complex type combining the porous layer and the pinhole, it is possible to dispose the porous layer at an upstream side of the pinhole in the measured gas flow. It is also possible to adjust the contribution degrees of the Knudsen diffusion and the molecular diffusion by appropriately grinding the porous layer. However, it is substantially difficult to control all of the temperature dependency, the pressure dependency, and the output adjustment by changing or adjusting one parameter (i.e. diffusion resistance of the porous layer).

### SUMMARY OF THE INVENTION

In view of the above-described problems, the present invention has an object to provide a gas sensing element which has predetermined temperature dependency and pressure dependency and is easy to adjust its output, and also has an object to provide a method for manufacturing this sensing element.

In order to accomplish the above and other related objects, the present invention provides a method for manufacturing a multilayered gas sensing element including a solid electrolytic substrate, a measured gas side electrode and a reference electrode provided on surfaces of the solid electrolytic substrate, a measured gas chamber in which the measured gas side electrode is provided, and an introducing hole forming layer with an introducing hole for introducing a measured gas from an ambient atmosphere into the measured gas chamber and also providing a diffusion resistance to the measured gas introduced into the measured gas chamber. The manufacturing method of the present invention includes a step of forming the introducing hole by performing laser irradiation applied to the introducing hole forming layer.

As described above, the temperature dependency with respect to the output of a gas sensing element and the pressure dependency in the output are dependent on the diameter of the introducing hole. In general, the gas sensing element is made of a ceramic body. As a method for processing the ceramic body, it is known to use a diamond grindstone, a drill, or other tools. Furthermore, according to a shot blast method, alumina powder or the like is sprayed against a portion where the introducing hole is formed. However, the diamond grindstone is not preferable for forming the introducing hole, although it is usually used to process a plane. The drill cannot be used to open a small hole having a diameter less than 100 μm because of its strength. The shot blast cannot accurately control the processing because it utilizes the airflow. Furthermore, the gas sensing element is generally manufactured by sintering a multilayered body of ceramic green sheets being laminated together. It may be possible to provide a through-hole in a green sheet of an introducing hole forming layer beforehand, for example, by punching. However, forming a through-hole having a diameter of 100 μm or less is difficult when the strength of a pin used in the punching processing is taken into consideration.

Considering these problems, the manufacturing method of the present invention uses the laser irradiation to form a through-hole. Irradiating the laser makes it possible to fuse and sublimate a predetermined position of the introducing hole forming layer to form a through-hole. The laser is a condensed beam having a focused higher energy density and is preferable to accurately control the irradiation position. Furthermore, it is possible to form a through-hole having an accurate diameter through an optical adjustment of the laser beam diameter and application of an appropriate mask. Thus, the manufacturing method of the present invention can easily obtain an introducing hole for the gas sensing element capable of possessing desired pressure characteristics and temperature characteristics.

Furthermore, it is possible to enlarge the size of introducing hole by repeating the laser irradiation at a portion neighboring to a formed introducing hole. Namely, the diameter of an existing introducing hole can be easily changed. Furthermore, by irradiating the laser to a portion other than an already formed introducing hole, an intended output can be arbitrarily obtained while the diameter of the introducing hole is controlled to a specific value (from the fact that the output of a gas sensing element depends on a sum of cross-sectional areas of the formed gas introducing holes. Accordingly, it becomes possible to easily realize output adjustment while maintaining a predetermined hole diameter. Furthermore, the laser irradiation processing is easily realized by using a laser oscillator. As described above, the present invention can provide a method for manufacturing a gas sensing element which has predetermined temperature dependency and pressure dependency and is easy to adjust its output.

The present invention provides a gas sensing element including a solid electrolytic substrate, a measured gas side electrode and a reference electrode provided on surfaces of the solid electrolytic substrate, a measured gas chamber in which the measured gas side electrode is provided, and an introducing hole forming layer with an introducing hole for introducing a measured gas from an ambient atmosphere into the measured gas chamber and also providing a diffusion resistance to the measured gas introduced into the measured gas chamber. The introducing hole is a through-hole formed by laser irradiation to have a diameter of 1 μm to 50 μm.

The gas sensing element of the present invention has an introducing hole formed by laser irradiation in the introducing hole forming layer. The diameter of this introducing hole is in the range from 1 μm to 50 μm. Irradiating the laser makes it possible to fuse and sublimate a predetermined position of the introducing hole forming layer to form a through-hole. The laser is a condensed beam having a focused higher energy density and is preferable to accurately control the irradiation position. Furthermore, it is possible to form a through-hole having an accurate diameter through an optical adjustment of the laser beam diameter and application of an appropriate mask. Thus, the present invention can easily obtain an introducing hole of the gas sensing element capable of possessing desired pressure characteristics and temperature characteristics. Furthermore, the laser irradiation processing can be easily realized by using a laser oscillator. Changing the diameter of the introducing is easily feasible. Furthermore, as the through-hole has a diameter in the range from 1 μm to 50 μm, the introducing hole has a diffusion resistance depending on both of the molecular diffusion and the Knudsen diffusion. Accordingly, when an introducing hole having a small diameter is provided, the gas sensing element does not produce an output depending on the temperature. When an introducing hole having a large diameter is provided, the gas sensing element does not produce an output depending on the pressure. Thus, it becomes possible to easily design a gas sensing element with reference to environments. Furthermore, considering availability of the optical axis adjustment performable for an irradiation apparatus used for the laser irradiation, it will be difficult to adjust the laser to form a through-hole having a diameter less than 1 μm. Furthermore, although the energy density can be increased by condensing the laser, the particles fused and sublimated by the laser irradiation will undesirably block the laser beam in a case that a processed hole has a diameter of 1 μm or less. As described above, the present invention can provide a gas sensing element which has predetermined temperature dependency and pressure dependency and is easy to adjust its output.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a cross-sectional view explaining a gas sensing element in accordance with a first embodiment of the present invention;

FIG. 2 is a perspective exploded view showing the gas sensing element in accordance with the first embodiment of the present invention;

FIG. 3 is a cross-sectional view explaining a method for forming an introducing hole of the gas sensing element by performing laser irradiation using a slit and a convex lens in accordance with the first embodiment of the present invention;

FIG. 4 is a cross-sectional view explaining a method for forming an introducing hole of the gas sensing element by performing laser irradiation using a convex lens and a concave lens in accordance with a second embodiment of the present invention;

FIG. 5 is a cross-sectional view explaining a method for controlling the processing applied to an introducing hole forming layer based on an optical observation of an irradiation position in accordance with a third embodiment of the present invention;

FIG. 6 is a plan view explaining a processing method of determining the diameter and number of required introducing holes based on a measured output value of the gas sensing element in accordance with a fourth embodiment of the present invention;

FIG. 7 is a cross-sectional view explaining a gas sensing element having a plurality of introducing holes in accordance with a fifth embodiment of the present invention;

FIG. 8 is a cross-sectional view explaining a gas sensing element of a 2-cell type in accordance with the fifth embodiment of the present invention;

FIG. 9 is a cross-sectional view explaining a gas sensing element having a porous layer disposed on the introducing hole forming layer in accordance with the fifth embodiment of the present invention;

FIG. 10 is a perspective exploded view showing a gas sensing element having an introducing hole extending from its side surface in accordance with the fifth embodiment of the present invention;

FIG. 11 is a flowchart showing a method for manufacturing a gas sensing element in accordance with a sixth embodiment of the present invention;

FIG. 12 is a plan view explaining a measured gas side electrode and its vicinity of a gas sensing element in accordance with a seventh embodiment of the present invention;

FIG. 13 is a plan view explaining an annular measured gas side electrode and its vicinity of a gas sensing element in accordance with the seventh embodiment of the present invention;

FIG. 14 is a cross-sectional view explaining a measured gas side electrode and its vicinity of a gas sensing element in accordance with an eighth embodiment of the present invention;

FIG. 15 is a plan view explaining a measured gas side electrode and its vicinity of a gas sensing element in accordance with a ninth embodiment of the present invention;

FIG. 16 is a perspective view explaining a method for forming an introducing hole of the gas sensing element in accordance with the ninth embodiment of the present invention;

FIG. 17 is a plan view explaining a measured gas side electrode and its vicinity of a gas sensing element in accordance with a tenth embodiment of the present invention;

FIG. 18 is a graph showing an output change of gas sensing element during hole forming processing in accordance with the tenth embodiment of the present invention;

FIG. 19 is a plan view explaining a measured gas side electrode and its vicinity of a gas sensing element in accordance with an eleventh embodiment of the present invention; and

FIG. 20 is a perspective exploded view showing a conventional gas sensing element.

### DESCRIPTION OF THE PREFERRED EMBODIMENTS

The present invention provides a multilayered gas sensing element including a solid electrolytic substrate. A measured gas side electrode and a reference electrode are provided on surfaces of this solid electrolytic substrate. The measured gas side electrode is provided in a measured gas chamber. An introducing hole forming layer has an introducing hole for introducing a measured gas from an ambient atmosphere into the measured gas chamber and also providing a diffusion resistance to the measured gas introduced into the measured gas chamber.

The manufacturing method of the present invention includes a step of forming the introducing hole by performing laser irradiation applied to the introducing hole forming layer.

According to the gas sensing element and its manufacturing method of the present invention, the measured gas side electrode and the reference electrode are provided on the solid electrolytic substrate having oxygen ionic conductivity. These paired electrodes cooperatively arrange an electrochemical cell. The concentration of a predetermined gas is measured based on an oxygen ion current flowing in this electrochemical cell. The gas sensing element according to the present invention is, for example, an oxygen sensing element capable of measuring the oxygen concentration in a measured gas, or a gas sensing element causing a specific gas, such as NOx, CO, and HC, to decompose and produce oxygen ions and capable of measuring the concentration of this specific gas based on the produced oxygen ions.

Furthermore, the gas sensing element according to the present invention is, for example, an A/F sensing element which is disposed in an exhaust device of an automotive internal combustion engine and is capable of measuring the oxygen concentration in the exhaust gas and measuring an air/fuel ratio in a combustion chamber of the internal combustion engine based on the measured oxygen concentration.

Furthermore, the introducing hole of the present invention has a diffusion resistance. Usually, the current value increases in proportion to the applied voltage. However, according to a gas sensing element having a diffusion resistance portion, the flow rate of the measured gas introduced from the outside is substantially determined by the diffusion resistance portion. This causes a region where the current does not substantially increase irrespective of increasing voltage. The current value in this region is referred to as a limiting current value. The limiting current value is proportional to a specific gas concentration in the measured gas. Thus, the specific gas concentration can be detected by measuring the limiting current value appearing when an appropriate voltage is applied between the measured gas side electrode and the reference electrode. The introducing hole according to the present invention is arranged by a through-hole which enables the gas sensing element to show such characteristics.

According to the gas sensing element manufacturing method of this embodiment, it is preferable that the diameter of the introducing hole is in a range from 1 μm to 50 μm. As the through-hole has a diameter in the range from 1 μm to 50 μm, the introducing hole has a diffusion resistance depending on both of the molecular diffusion and the Knudsen diffusion. Accordingly, when an introducing hole having a small diameter is provided, the gas sensing element does not produce an output depending on the temperature. When an introducing hole having a large diameter is provided, the gas sensing element does not produce an output depending on the pressure. Thus, designing a gas sensing element in accordance with environments becomes easy. Furthermore, considering availability of the optical axis adjustment performable for an irradiation apparatus used for the laser irradiation, it will be difficult to adjust the laser to form a through-hole having a diameter less than 1 μm. Furthermore, although the energy density can be increased by condensing the laser, the particles fused and sublimated by the laser irradiation will undesirably block the laser beam in a case that a processed hole has a diameter of 1 μm or less. Furthermore, as the laser irradiation is the processing inducing fusion and sublimation of particles, dissipation of processing heat may become insufficient in the processing of a large hole. The element may be broken due to thermal stress. Accordingly, it is desirable that the diameter is equal to or less than 50 μm.

Furthermore, according to the gas sensing element manufacturing method of this embodiment, it is preferable that the introducing hole consists of a plurality of holes. According to the manufacturing method of the present invention, it is possible to form a through-hole having a desired diameter. Thus, it is possible to obtain a gas sensing element capable of suppressing variations in the temperature characteristics or pressure characteristics which depend on a pore diameter of the through-hole. Furthermore, providing plural introducing holes makes it easy to obtain a gas sensing element having a required output. More specifically, in a case that using a small hole is preferable from the requirements of temperature characteristics and pressure characteristics, providing numerous small introducing holes can provide a sufficient area of the introducing holes equivalent to a large through-hole.

Furthermore, according to the gas sensing element manufacturing method of this embodiment, it is preferable that at least one of the plural introducing holes is formed before sintering the gas sensing element. In this case, the above-described introducing hole can be formed before the introducing hole forming layer is hardened. Thus, the introducing hole can be formed easily without requiring a long time.

Furthermore, according to the gas sensing element manufacturing method of this embodiment, it is preferable that an output value of the gas sensing element is measured when the laser irradiation is performed, and diameter and number of required introducing hole (or holes) is determined with reference to the output value of the gas sensing element. Determining the number of introducing holes with reference to the measured output brings the effect of surely obtaining a gas sensing element having intended output characteristics.

Furthermore, according to the gas sensing element manufacturing method of this embodiment, it is preferable to perform the laser irradiation by using a pulse oscillation laser. In this case, it is preferable that a wavelength of the laser is equal to or less than 350 nm. Furthermore, it is preferable that a pulse half-value width of the laser is equal to or less than 1 ps. For example, the laser irradiation is performed by using an excimer laser or a YAG laser using a third harmonic generator, or by using a titanium sapphire laser.

The gas sensing element is made of a ceramic body. If the laser processing is applied to the ceramic body, heat generation will locally occur and may cause cracks at or in the vicinity of the region where the laser is irradiated. This problem can be solved by using a pulse oscillation laser, because the laser irradiation can be performed intermittently. In this case, a pulse oscillation laser having the oscillation pulse half-value width equal to or less than 1 ps is preferable because it can reduce or eliminate the above-described cracks caused by local heat generation. Especially, a titanium sapphire laser is preferable in that it has the capability of producing an extremely short pulse of approximately 100 fs. Furthermore, even if the oscillation pulse is not so short, using the oscillation wavelength of ultraviolet ray is effective in preventing the above-described cracks. The laser of ultraviolet ray mainly depends on the light energy to process the ceramic body and hence causes substantially no cracks. Accordingly, it is preferable to use the laser having a wavelength equal to or less than 350 nm. The above-described laser is, for example, an excimer laser which is excellent in the oscillation wavelength and the output. For example, ArF, KrF, XeCl or other excited two-atomic molecules (i.e. excited dimer) can be used as an oscillation medium. Besides the above-described laser devices, a YAG laser using a third harmonic generator (THG) can be used to obtain similar effects. Regarding the excimer laser, the shortest wavelength is 192 nm (ArF). In a case that the wavelength less than 192 nm is used, it may be possible to use a second harmonic generator (i.e. SHG) or a free electron laser. The former is not desirable in that the energy loss occurs in the wavelength conversion and also in that the processing time is long. The latter is not desirable in that a very large-scale apparatus is required and accordingly the cost is increased. Accordingly, it is desirable to use the wavelength equal to or greater than 192 nm.

Furthermore, according to the gas sensing element manufacturing method of this embodiment, it is preferable that a focal position of the laser is changed with reference to progress in the process of forming an introducing hole by using the laser. This is because the introducing hole forming layer has a significant thickness and accordingly a processing position deviates from the focal position in the process of forming the introducing hole by irradiating the laser. The condensing beam diameter becomes larger. Accordingly, the focal position of the laser should be adjusted with reference to progress of laser irradiation, although the focal position of the laser is initially adjusted on the surface of the introducing hole forming layer. Hence, adjusting the focal position of the laser with reference to progress of the laser processing can realize formation of an introducing hole having a uniform diameter. Regarding the change of this focal position, to ensure an accurate formation of the introducing hole, it is desirable to continuously adjust the focal position at real time in accordance with the progress of laser processing. However, it will be practically sufficient to execute the adjustment of focal position several times during the laser processing.

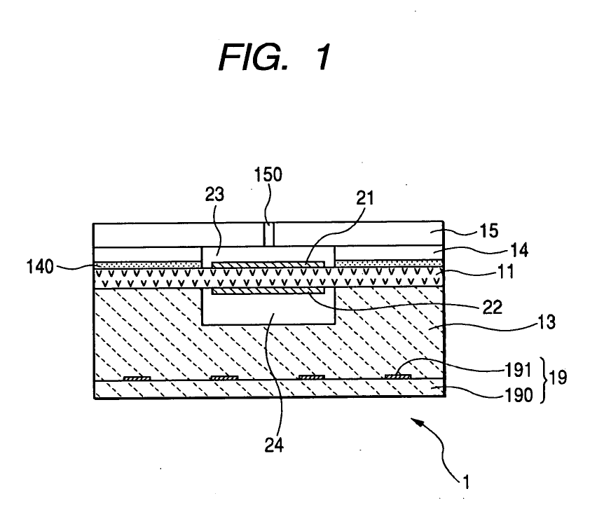

Furthermore, according to the gas sensing element manufacturing method of this embodiment, it is preferable that the laser processing applied to the introducing hole forming layer is controlled by optically observing an irradiation position of the laser irradiated onto the introducing hole forming layer. This makes it possible to prevent the laser irradiation from damaging any portion other than the introducing hole forming layer. In the process of forming the introducing hole, it is necessary to quickly stop the laser irradiation when the introducing hole is opened so that the damage of an inner region positioned beneath the introducing hole forming layer can be minimized. The light emitting from the irradiation position has a wavelength inherent to the material being currently processed by the laser irradiation. Hence, observing this light makes it possible to detect the portion being currently processed by the laser irradiation. According to the structure of a general gas sensing element, the layer positioned beneath the introducing hole forming layer is a solid electrolytic substrate or the like which is formed by a different material. Accordingly, by optically observing the light emitting from the irradiation position, it is possible to accurately detect the timing that the laser reaches the inner layer beneath the introducing hole forming layer. The laser irradiation can be accurately stopped. Furthermore, in a case that a measured gas chamber or any other inner space is present under the introducing hole forming layer as shown in the later-described FIG. 1, it is possible to stop the laser irradiation based on a beam strength change at the laser oscillation wavelength occurring due to change in the scattering of the laser beam when the introducing hole is opened.

Furthermore, according to the gas sensing element manufacturing method of this embodiment, it is preferable that a projection of the measured gas chamber to the surface of the solid electrolytic substrate is present in an electrode non-forming region where the measured gas side electrode is not formed, and the introducing hole formed in the introducing hole forming layer is in the electrode non-forming region. In this case, in the process of forming the introducing hole, no laser is irradiated on the measured gas side electrode. More specifically, immediately after the introducing hole is opened across the introducing hole forming layer, the laser is irradiated on the electrode non-forming region and accordingly no laser is irradiated on the measured gas side electrode. Accordingly, it becomes possible to prevent the damage of the measured gas side electrode.

Furthermore, according to the gas sensing element manufacturing method of this embodiment, it is preferable that a protecting member protecting the solid electrolytic substrate is disposed in the electrode non-forming region of the measured gas chamber, and the introducing hole is provided in a predetermined region of the introducing hole forming layer wherein a projection of the protecting member is formed. This arrangement can prevent the laser from irradiating the solid electrolytic substrate. Thus, the solid electrolytic substrate is not damaged by the laser.

Furthermore, according to the gas sensing element manufacturing method of this embodiment, it is preferable that the process of performing the laser irradiation includes an adjustment of a focal position of the laser in accordance with optical displacement of a processing point caused by thermal effect of the gas sensing element. In this case, it becomes possible to efficiently form an introducing hole having an accurate size. Namely, in the case that the formation of the introducing hole is performed while the output of a gas sensing element is measured, the gas sensing element will be heated and its temperature will increase. In this case, the gas sensing element will slightly cause warpage or other thermal deformation. Ambient air will optically fluctuate due to the heat of gas sensing element. The processing point may optically deviate due to refraction. In this case, if the laser irradiation is performed while keeping the focal position having been adjusted before the gas sensing element is heated, the focal position will cause deviation and the condensing beam diameter at the processing position will increase. Therefore, the diameter of a formed introducing hole becomes larger and the time required for opening the introducing hole becomes longer. Thus, the efficiency of laser processing decreases. Hence, as described above, adjusting the focal position of the laser immediately before performing the laser irradiation makes it possible to efficiently form an accurate introducing hole even if a gas sensing element causes a thermal effect.

Furthermore, according to the gas sensing element manufacturing method of this embodiment, it is preferable that the laser irradiation is performed by shifting an irradiation position of the laser relative to the introducing hole forming layer while an output value of the gas sensing element is measured so as to form the introducing hole having an elongated shape, and the length of the introducing hole is determined in accordance with the output value of the gas sensing element. This arrangement makes it possible to easily perform fine adjustment of output value of a gas sensing element. Namely, in a case that the output value of a gas sensing element is adjusted by increasing the number of introducing holes, the output value increases stepwise in accordance with increase of the number. On the other hand, in a case that the output value of a gas sensing element is adjusted by increasing the length of an elongated introducing hole, the output value increases smoothly and continuously in accordance with increase of the length. Accordingly, fine adjustment of the output value can be easily performed.

Furthermore, according to the gas sensing element manufacturing method of this embodiment, it is preferable that a forming position of the introducing hole represents identification information of the gas sensing element. In this case, the introducing hole can possess a function of identifying the information, such as output characteristics, of the gas sensing element.

According to the gas sensing element of this embodiment, it is preferable that a projection of the measured gas chamber to the surface of the solid electrolytic substrate is present in an electrode non-forming region where the measured gas side electrode is not formed, and the introducing hole formed in the introducing hole forming layer is in the electrode non-forming region. This arrangement can prevent the damage of the above-described measured gas side electrode.

Furthermore, according to the gas sensing element of this embodiment, it is preferable that a protecting member protecting the solid electrolytic substrate is disposed in the electrode non-forming region of the measured gas chamber, and the introducing hole is provided in a predetermined region of the introducing hole forming layer wherein a projection of the protecting member is formed. This arrangement can prevent the solid electrolytic substrate from being damaged.

Furthermore, according to the gas sensing element of this embodiment, it is preferable that the introducing hole of the introducing hole forming layer has an elongated shape. In this case, fine adjustment of the output value of the gas sensing element can be easily performed.

Furthermore, according to the gas sensing element of this embodiment, it is preferable that a forming position of the introducing hole represents identification information of the gas sensing element. In this case, the introducing hole can possess the function of identifying the information of the gas sensing element.

Hereinafter, practical embodiments of the present invention will be explained hereinafter with reference to attached drawings.

### First Embodiment

A method for manufacturing a gas sensing element in accordance with a first embodiment of the present invention will be explained with reference to FIGS. 1 to 3. The gas sensing element of the first embodiment is a multilayered gas sensing element including a solid electrolytic substrate. A measured gas side electrode and a reference electrode are provided on surfaces of this solid electrolytic substrate. The measured gas side electrode is provided in a measured gas chamber. An introducing hole forming layer has an introducing hole for introducing a measured gas from an ambient atmosphere into the measured gas chamber and also providing a diffusion resistance to the measured gas introduced into the measured gas chamber. In manufacturing this gas sensing element, laser irradiation is applied onto the introducing hole forming layer to form the introducing hole.

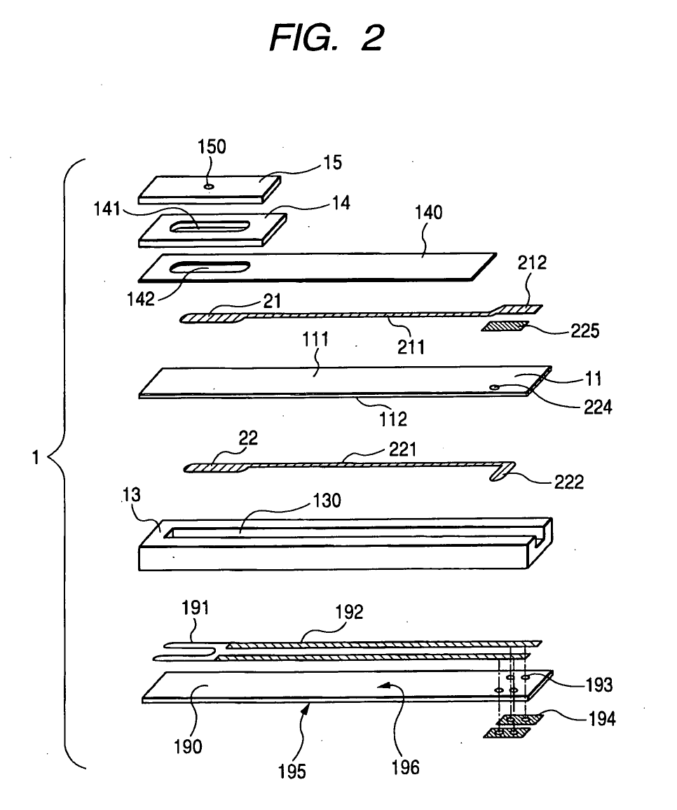

More specifically, the gas sensing element of this embodiment is a limiting-current type element incorporated in a gas sensor which is installed in an exhaust device of an automotive engine to detect an air-fuel ratio of this engine based on the oxygen concentration in the exhaust gas. As shown in FIGS. 1 and 2, the gas sensing element 1 of this embodiment includes a heater 19 consisting of a heating element 191 provided on a heater substrate 190. A reference gas chamber spacer 13 (i.e. a spacer for forming a reference gas chamber 24) is laminated on the heater 19. A solid electrolytic substrate 11 is laminated on the reference gas chamber spacer 13. A measured gas chamber spacer 14 (i.e. a spacer for forming a measured gas chamber 23) is laminated via an insulating layer 140 on the solid electrolytic substrate 11. An introducing hole forming layer 15 is laminated on the measured gas chamber spacer 14. The solid electrolytic substrate 11 has a surface 112 defining a ceiling of the reference gas chamber 24. A reference electrode 22 is provided on the surface 112 of the solid electrolytic substrate 11. Furthermore, the solid electrolytic substrate 11 has a surface 111 defining a bottom of the measured gas chamber 23. A measured gas electrode 21 is provided on the surface 111 of the solid electrolytic substrate 11.

The measured gas chamber spacer 14 has a window portion 141, and the insulating layer 140 has a window portion 142. These window portions cooperatively form the measured gas chamber 23. The reference gas chamber spacer 13 has a groove portion 130 forming the reference gas chamber 24. A lead portion 221 and an internal terminal 222, connected to the reference electrode 22, are provided on the surface 112 of the solid electrolytic substrate 11. The internal terminal 222 is connected via a through-hole 224 to a terminal 225 which is exposed to the outside of the gas sensing element 1. A lead portion 211 and a terminal 212, connected to the measured gas side electrode 21, are provided on the surface 111 of the solid electrolytic substrate 11. The introducing hole forming layer 15 has an introducing hole 150 opened as a through-hole extending from the ambient atmosphere to the measured gas chamber 23. According to the gas sensing element 1 of this embodiment, only one introducing hole 150 is provided. Furthermore, the heating element 191 and its lead portions 192 are provided on a surface 196 of the heater substrate 190 of the heater 19. The lead portions 192 are connected via through-holes 193 to terminals 194 provided on a surface 195 of the heater substrate 190. According to the gas sensing element 1 of this embodiment, the solid electrolytic substrate 11 is a zirconia ceramic member and the other plate members are alumina ceramic members. The measured gas side electrode 21 (including the lead portion 211 and the terminal 212), the reference electrode 22 (including the lead portion 221, the internal terminal 222, and the terminal 225), the heater electrode 191, the lead portions 192, and the terminal 194 are platinum members.

The gas sensing element 1 of this embodiment is manufactured in the following manner.

First of all, ceramic green sheets are prepared to respectively form the heater substrate 190, the reference gas chamber spacer 13, the solid electrolytic substrate 11, the insulating layer 140, the measured gas chamber spacer 14, and the introducing hole forming layer. Then, the heating element 191, the reference electrode 22, and the measured gas side electrode 21 are printed at predetermined portions of corresponding sheets. Then, these sheets are successively laminated and pressed to obtain a green (i.e. unburned) multilayered body. Then, this green multilayered body is sintered at a predetermined temperature to obtain a sintered body. This sintered body has no introducing hole yet.

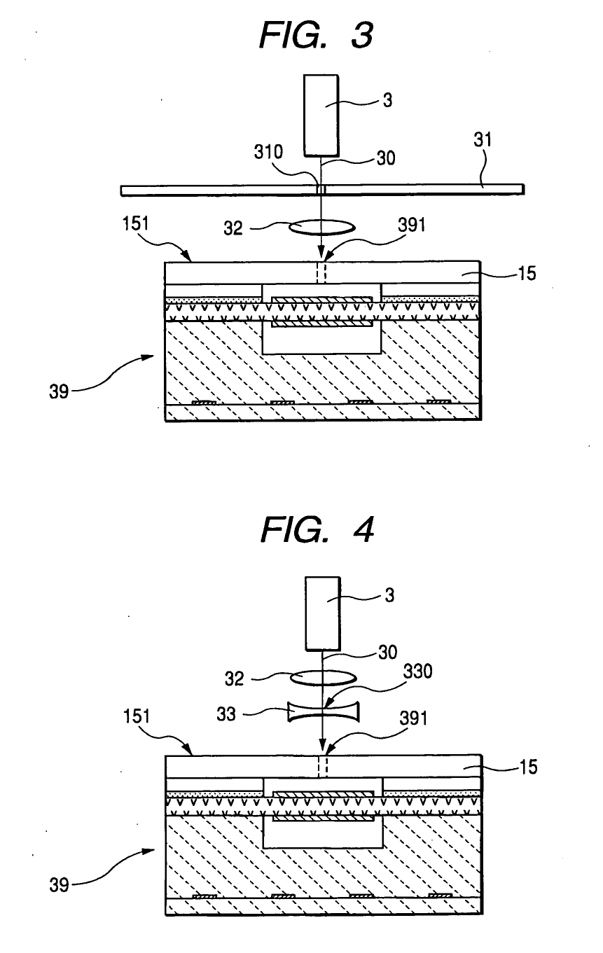

Then, to open the introducing hole 150, the laser irradiation is applied onto the introducing hole forming layer 15. As shown in FIG. 3, a laser generator 3 irradiates a laser 30 to an irradiation position 391 on a surface 151 of the introducing hole forming layer 15 of a sintered body 39. In this case, a mask 31 with a slit 310 is disposed between the laser generator 3 and the sintered body 39. A convex lens 32 of a movable type is also disposed between the laser generator 3 and the sintered body 39. The convex lens 32 adjusts the focal position of the laser 30 to the irradiation position 391. The laser generator 3 is an excimer laser (using a KrF laser having the wavelength of 248 nm). The oscillation laser beam has an output of 5 W, and the pulse oscillation frequency is 100 Hz. Furthermore, the slit 310 has a width of 150 μm. The convex lens 32 has a magnification of 30 times. Even if the excimer laser is replaced with a YAG laser using a third harmonic generator (THG) or a titanium sapphire laser, similar effects will be obtained. Hereinafter, the excimer laser is explained as a representative example.

The introducing hole 150 is formed in the following manner. The laser generator 3 emits the laser 30 which passes the mask 31 and the convex lens 32 and reaches the irradiation position 391. The mask 31 collimates the laser 30. The convex lens 32 causes the laser 30 to converge. When the laser 30 arrives at the irradiation position 391, the substance of this portion fuses and sublimates to leave a recess. The depth of this recess is substantially proportional to the irradiation time of the laser. The position of convex lens 32 is gradually shifted toward the introducing hole forming layer 15 in accordance with the irradiation time. The focal point of the convex lens 32 shifts from the surface 151 to the bottom of the recess. The energy of the laser irradiation is maximized at the focal point of the convex lens 32. Thus, the energy of the laser 30 can be effectively utilized. When the depth of this recess becomes equal to the thickness of the introducing hole forming layer 15, the through-hole (i.e. introducing hole 150) is opened. At this moment, the laser irradiation is stopped. As a result, the gas sensing element 1 has the introducing hole forming layer 15 provided with the introducing hole 150.

The introducing hole 150, having been formed in this manner, has a diameter of 5 μm. The temperature dependency in the output is approximately 0.05%/° C., and the pressure dependency is approximately 0.15%/kPa. When the introducing hole 150 has a diameter of 30 μm, the temperature dependency in the output becomes approximately 0.2%/° C. and the pressure dependency becomes approximately 0.05%/kPa. In this manner, when used in an environment having small temperature variations, it is desirable to increase the diameter of the introducing hole to suppress the pressure dependency. According to the laser irradiation of this embodiment, it is easy to obtain an accuracy of ±10% or less (relative to the introducing hole diameter value) although the accuracy of the diameter of introducing hole 150 depends on the accuracy of optical axis adjustment.

As described above, the manufacturing method of this embodiment uses the laser irradiation to form the introducing hole 150. The substance of a predetermined position of the introducing hole forming layer 15 fuses and sublimates when subjected to the laser irradiation and leaves the through-hole there. The laser can possess a focused high energy density when condensed and is preferable to precisely control the irradiation position. Furthermore, the optical adjustment of the laser beam diameter and application of an appropriate mask can assure the through-hole to have an accurate diameter. Hence, this embodiment can obtain the introducing hole 150 capable of providing the gas sensing element 1 having desired pressure characteristics and temperature characteristics.

Furthermore, the gas sensing element 1 according to this embodiment can obtain an appropriate diffusion resistance because of the introducing hole 150 which can be precisely formed as described above. Accordingly, the gas sensing element has predetermined temperature dependency and pressure dependency. Furthermore, the laser irradiation processing can be easily realized by using the laser generator 3. The laser generator 3 used in this embodiment is a KrF laser having the oscillation wavelength of 248 nm, the output of 5 W, and the pulse oscillation frequency of 100 Hz. However, it is possible to use a YAG laser using a third harmonic generator (THG), or a titanium sapphire laser. Accordingly, no cracks occur at or in the vicinity of the region where heat generation locally occurs due to laser irradiation. It becomes possible to precisely obtain the introducing hole 150. As described above, this embodiment can provide a gas sensing element which has predetermined temperature dependency and pressure dependency and is easy to adjust its output, and also can provide a manufacture method for this sensing element.

### Second Embodiment

This embodiment is, as shown in FIG. 4, characterized in that the convex lens 32 and a concave lens 33 are used to irradiate the laser onto the introducing hole forming layer 15. More specifically, both the convex lens 32 and the concave lens 33 are disposed between the laser generator 3 and the sintered body 39, so that the focal point of the convex lens 32 is positioned on the surface 330 of the concave lens 33. The laser 30 emitted from the laser generator 3 converges at the convex lens 32 and forms a focus on or in the vicinity of the surface of the concave lens 33. The laser, after having entered in the concave lens 33, becomes a parallel beam while keeping a beam diameter and then exits out of the concave lens 33. Then, the laser arrives at the irradiation position 391 on the surface 151 of the introducing hole forming layer 15. Accordingly, this embodiment adjusts both the convex lens 32 and the concave lens 33 to obtain a parallel beam having an arbitrary diameter which is smaller than the original diameter of the laser generator 3. Regarding other detailed arrangement, this embodiment is similar to the first embodiment.

In the case of using the laser irradiation method of this embodiment, it is unnecessary to use a mask or the like to adjust the laser beam diameter. The laser output can be effectively used because the laser beam is not shielded unnecessary. The time required for forming the introducing hole can be shortened. Furthermore, it is easy to obtain a parallel beam and accordingly an ideal through-hole having an accurate hole diameter can be obtained. Regarding the rest of functions and effects, this embodiment is similar to the first embodiment.

### Third Embodiment

This embodiment is characterized in that, in manufacturing a gas sensing element having an introducing hole similar to that of the first embodiment, the laser irradiation processing is controlled by optically observing the irradiation position 391 of the laser 30 irradiated onto the introducing hole forming layer 15.

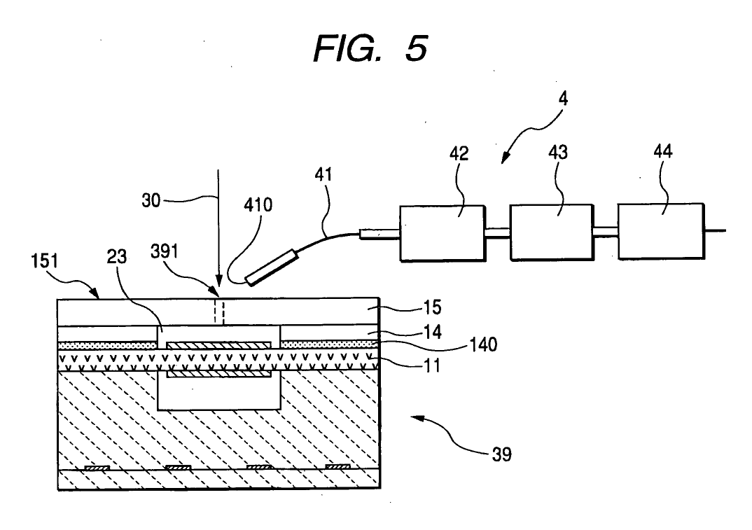

Hereinafter, this embodiment will be explained in more detail. As shown in FIG. 5, an optical observing apparatus 4 is prepared. More specifically, the optical observing apparatus 4 includes an optical fiber 41, a visible-to-ultraviolet light range spectroscope 42, a photoelectric converter 43, and an A/D converter recorder-controller 44. The optical fiber 41 transmits a light emitted from the irradiation position 391 to the visible-to-ultraviolet light range spectroscope 42. The photoelectric converter 43 is placed behind the visible-to-ultraviolet light range spectroscope 42. The A/D converter recorder-controller 44 is placed behind the photoelectric converter 43. Furthermore, the optical observing apparatus 4 has the capability of transmitting a signal to an output control system of the laser generator (not shown in the drawing). A distal end 410 of the optical fiber 41 is disposed near the irradiation position 391 to capture the light emitted from the irradiation position 391. However, the visible-to-ultraviolet light range spectroscope 42 can be replaced with an optical filter if the wavelength resolution is not strictly required. Furthermore, a photo diode or a photomultiplier can be used as the photoelectric converter 43.

After the above-described optical observing apparatus 4 is installed, the processing is started by irradiating the laser 30 to the irradiation position 391. As soon as the processing starts, the alumina ceramic (refer to the first embodiment) fuses and sublimates at the irradiation position 391 as it arranges the introducing hole forming layer 15. In this case, an emitted light includes a wavelength (394 to 397 nm) inherent to aluminum. This light is introduced via the optical fiber 41 into the visible-to-ultraviolet light range spectroscope 42, in which wavelength components is analyzed. Thus, it becomes possible to confirm the above-described wavelength of the light emitted from aluminum. The analyzed light is converted into an electric signal via the photoelectric converter 43 and the A/D converter recorder-controller 44. Then, the output strength of a wavelength of the light emitted from aluminum is confirmed as the strength of the electric signal and is recorded as output strength at the time the processing starts. Subsequently, the output signal representing the wavelength of the light emitted from aluminum is continuously monitored during the processing. When the output strength is equal to or greater than a predetermined value, a laser output control system is instructed to continuously irradiate the laser.

As apparent from FIG. 5 and the arrangement of the first embodiment, the introducing hole 150 is a through-hole extending from the measured gas chamber 23 to the outside of the element. The measured gas side electrode 21 is positioned below the introducing hole 150. Although not shown in FIG. 5, there will be the possibility that the solid electrolytic substrate 11 is present below the introducing hole 150 if the position of the introducing hole 150 is changed. The measured gas electrode 21 is made of platinum as described in the first embodiment. The solid electrolytic substrate 11 is made of zirconia ceramic.

Accordingly, if the formation of the introducing hole 150 is accomplished, the laser will hit the solid electrolytic substrate 11 or the measured gas side electrode 21. In this case, the wavelength of a light emitted from aluminum is not observed. Instead, the wavelength of a light emitted from zirconia or platinum is observed. Namely, when the optical observing apparatus 4 confirms that the output signal representing the wavelength of the light emitted from aluminum becomes less than a predetermined level, it can be regarded that formation of the introducing hole 150 is accomplished and the laser is now reaching the portion existing below the introducing hole 150. Accordingly, it is preferable to instruct the laser output control system to stop the laser irradiation when the optical observing apparatus 4 detects that the output signal is reduced from its initial output signal level, for example, by 10%. This level is not limited to 10% and can be arbitrarily changed. Furthermore, an appropriate level will be determined with reference to the result obtained from the laser irradiation actually applied to the sintered body. Thus, the laser output control system stops the laser irradiation to accomplish formation of the introducing hole 150. Performing the laser irradiation according to this method makes it possible to prevent the laser from damaging any portion of the gas sensing element other than the introducing hole forming layer 15.

Furthermore, more accurate stop conditions of laser irradiation will be obtained if the visible-to-ultraviolet light range spectroscope 42 observes the wavelength of a light emitted from zircon and/or the wavelength of a light emitted from platinum in addition to the wavelength of a light emitted from aluminum. When the wavelength of a light emitted from zircon is observed, it is apparent that the laser has reached the solid electrolytic substrate 11. When the wavelength of a light emitted from platinum is observed, it is apparent that the laser has reached the measured gas electrode 21. Furthermore, in a case that the measured gas chamber or other space is present below the introducing hole forming layer as shown in FIG. 1, it is possible to stop the laser irradiation processing by observing a beam strength change at the laser oscillation wavelength occurring due to change in the scattering of the laser beam when the introducing hole is opened.

### Fourth Embodiment

This embodiment is characterized in that, in manufacturing a gas sensing element having an introducing hole similar to that of the first embodiment, an output value of the gas sensing element is measured during the laser irradiation and then the diameter of the introducing hole and the number of required introducing holes are determined in accordance with the measured output value.

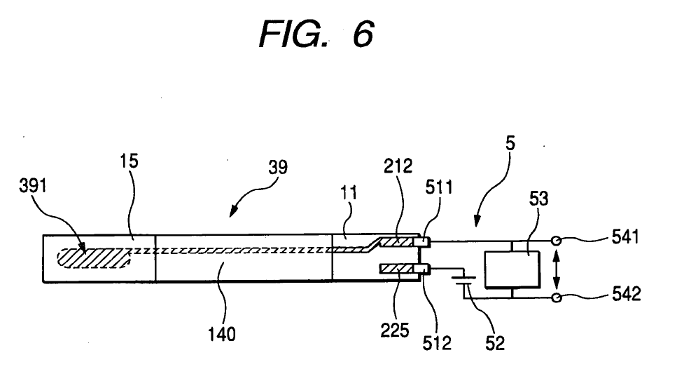

Hereinafter, this embodiment will be explained in more detail. As shown in FIG. 6, a detection circuit 5 is prepared. More specifically, the detection circuit 5 includes terminals 511 and 512, a power source 52, a resistor 53, and measuring terminals 541 and 542. The terminals 511 and 512 are respectively connected to the terminals 212 and 225 of the sintered body 39 (refer to the first embodiment) which becomes a gas sensing element after accomplishing formation of the introducing hole. The power source 52 is connected to the terminal 512. The resistor 53 is connected between the power source 52 and the terminal 511. The measuring terminals 541 and 542 are provided for measuring a voltage drop between the terminal 511 and the power source 52 under the condition that the resistor 53 is interposed between them. According to this embodiment, the power source 52 is a DC power source of 0.4V to 0.8V and the resistor 53 is 100 Ω. The voltage applied to the sintered body 39 (which becomes a gas sensing element) is equal to a different between the voltage generated from the DC power source 52 and the voltage drop at the resistor 53. As the current measurement is performed in the above-described limiting current region, the current output does not cause substantial change even if the voltage applied to the sintered body 39 causes variations. Thus, it becomes possible to obtain a stable current output value.

The detection circuit 5 is connected to the sintered body 39 before the introducing hole 150 is formed. Next, electric power is supplied to the heater of the sintered body 39 (refer to the first embodiment) to increase the element temperature up to 750° C. Thereafter, this temperature is maintained by adjusting electric power supplied to the heater. The output of the element in the sintered body 39 is measured in this condition. This value is regarded as an initial output value. Regarding the measurement of the output of this element, the detection circuit 5 obtains a current value (=voltage drop value/electric resistance value of the resistor) from a voltage drop between the terminal 541 and the terminal 542. This current value is regarded as an output current value of the element. Then, the laser is irradiated to the irradiation position 391 to start the processing while maintaining the above-described temperature condition of the element. The output is continuously measured during the processing. The laser irradiation is stopped when the output becomes a predetermined value because formation of the introducing hole is completed. The laser irradiation processing is finished. Thereafter, electric power supply to the heater of the gas sensing element is also stopped. The element, as a finished product, is disengaged from the detection circuit. In this case, it will be possible to form a plurality of introducing holes if the predetermined output is not obtained when one introducing hole is formed. Furthermore, it is possible to change the diameter of the introducing hole. To change the diameter of the introducing hole, it is preferable to adjust the laser irradiation by changing the diameter of a mask or the lens position. Furthermore, it is also preferable to once stop the laser irradiation to form a stable environment for measuring the output of the sintered body being currently processed, and then resume the laser irradiation to restart the processing after finishing the measurement of the output.

As described above, the manufacturing method of this embodiment can surely obtain a gas sensing element having an intended output by determining the diameter of the introducing hole and the number of required holes.

### Fifth Embodiment

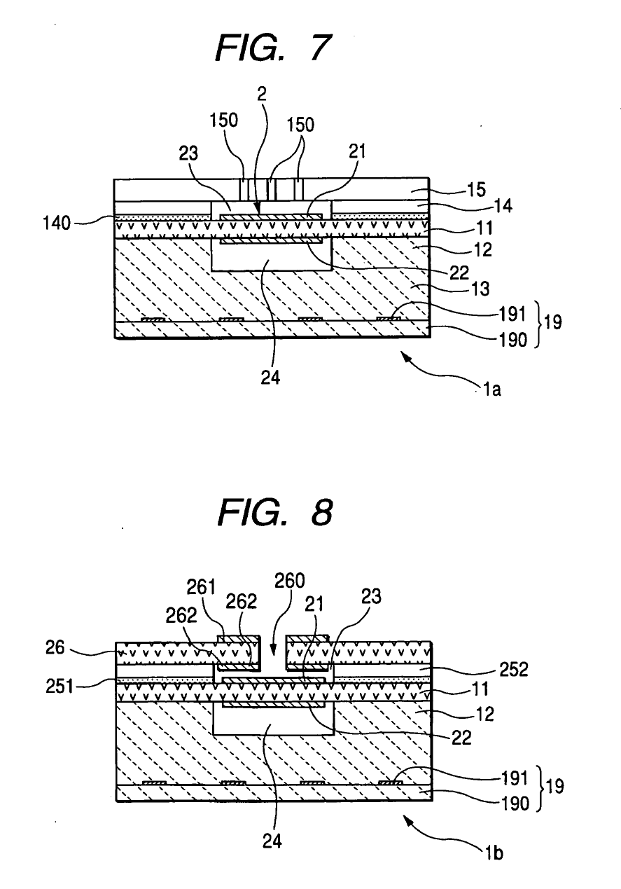

This embodiment is different from the first embodiment in the arrangement of a gas sensing element. FIG. 7 shows a gas sensing element 1a having a plurality of introducing holes 150. Regarding other detailed arrangement, this embodiment is similar to the first embodiment.

FIG. 8 shows a 2-cell type gas sensing element 1b. More specifically, a reference gas chamber forming spacer 12, a solid electrolytic substrate 11, an insulating layer 251, a measured gas chamber forming spacer 252, and an introducing hole forming layer 26 (serving as a solid electrolytic substrate) are provided on a heater 19. One pump electrode 261 is provided on an outer surface of the introducing hole forming layer 26 so as to be exposed to the outside of the element. The other pump electrode 262 is provided on an inner surface of the introducing hole forming layer 26 so as to be located in the measured gas chamber 23. An introducing hole 260, introducing the measured gas from the outside to the measured gas chamber 23, is provided so as to penetrate and extend from the pump electrode 261 to the pump electrode 262. The introducing hole forming layer 26 is made of zirconia, and the pump electrodes 261 and 262 are made of platinum. Regarding other detailed arrangement, this embodiment is similar to the first embodiment.

Furthermore, in the case that the introducing hole 260 is formed by using the method of the third embodiment to optically observe the laser irradiation, it is difficult to control the laser irradiation based on the observation of the wavelength of a light emitted from aluminum. Accordingly, it is necessary to observe the wavelength of a light emitted from zircon. Or, it is necessary to observe the wavelength of a light emitted from platinum of the outer pump electrode 261 and then observe the wavelength of a light emitted from platinum of inner pump electrode 262. Then, the laser irradiation is stopped. Of course, it is possible to control the laser irradiation by using the method detecting the change in the scattering of the laser beam.

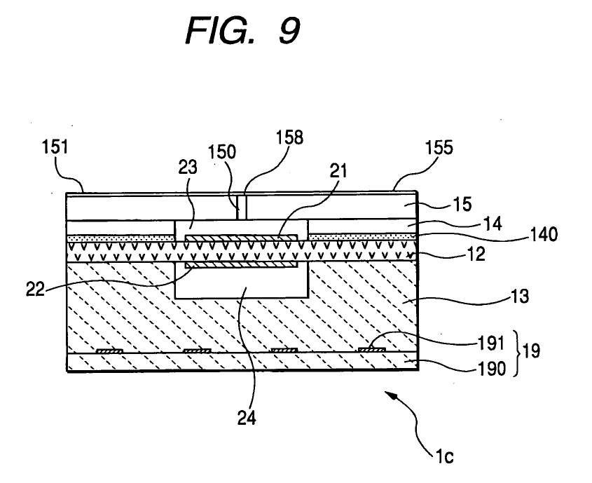

FIG. 9 shows a modified gas sensing element 1c which is different from the gas sensing element 1 of the first embodiment in that a porous layer 155 is provided on the surface of the introducing hole forming layer 15.

According to this example, after the introducing hole 150 is provided in the introducing hole forming layer 15, the alumina slurry using alumina dip is coated on the surface 151 of the introducing hole forming layer 15 (in this case, an opening 158 of the introducing hole 150 is closed by the alumina slurry since it has surface tension). Then, the element body is sintered to obtain the porous layer 155 which has higher porosity and accordingly has substantially no diffusion resistance. The porous layer 155 has a film thickness of 20 μm to 80 μm. Furthermore, alumina grains contained in the alumina dip has grain diameters of 5 μm to 50 μm. Providing this porous layer 155 can improve the sensor durability against harmful substances and can prevent the harmful components of exhaust gas from entering into the sensor. In other words, the porous layer 155 can protect the electrode from harmful substances and accordingly can maintain sensor performances appropriately. Regarding other detailed arrangement, this example is similar to the first embodiment.

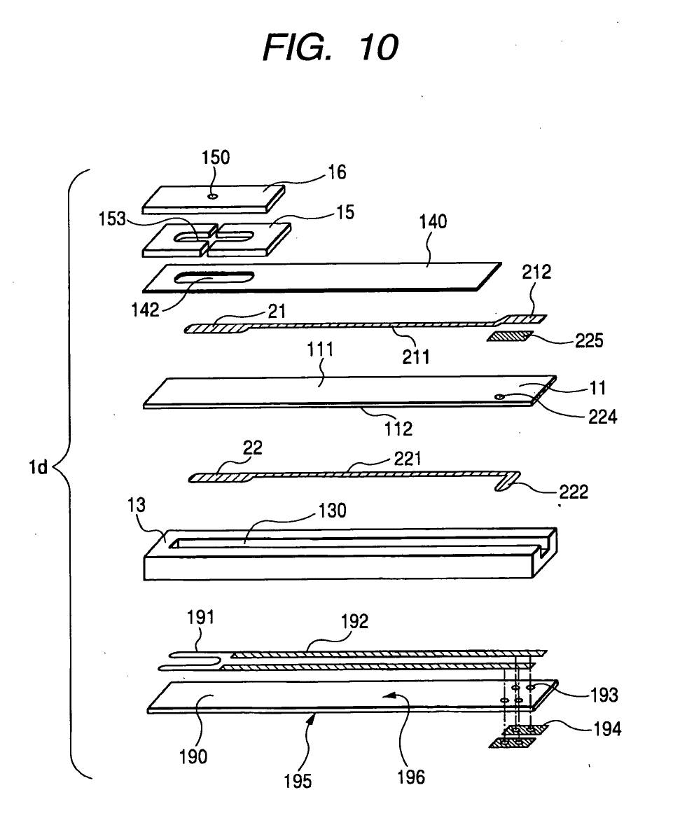

FIG. 10 shows a modified gas sensing element Id which has an introducing hole 150 provided at the side surface of the gas sensing element.

More specifically, an insulating layer 140 is laminated on the solid electrolytic substrate 11. An introducing hole forming layer 15, serving as a measured gas chamber spacer, is provided on the insulating layer 140. A shielding layer 16 is provided on the introducing hole forming layer 15. The introducing hole forming layer 15 has a window portion 153 defining the measured gas chamber. The introducing hole 150, extending from the side surface of the sensing element to the window portion 153, introduces the exhaust gas to the measured gas chamber. Regarding other detailed arrangement, this example is similar to the first embodiment.

### Sixth Embodiment

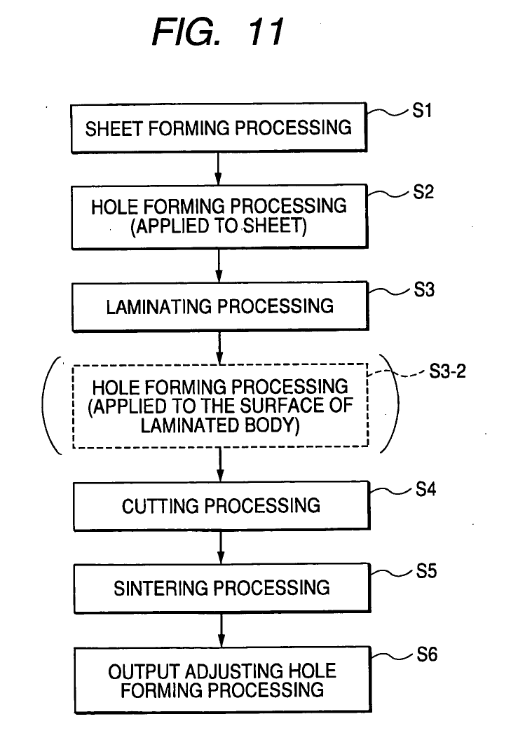

This embodiment is, as shown in FIG. 11, characterized in that at least one of introducing holes 150 is formed before sintering the gas sensing element 1 in the case that a plurality of introducing holes 150 are formed.

More specifically, first of all, green sheets of the solid electrolytic substrate 11, the introducing hole forming layer 15, and others (refer to FIG. 2) are formed (step S1). Next, a through-hole (or through-holes) is formed by irradiating the laser onto the green sheet of introducing hole forming layer 15 (step S2). The number of the through-hole (or through-holes) formed in this case is smaller than the total number of required introducing holes 150 corresponding to an output value of finally obtained gas sensing element 1. Next, the green sheets are laminated (step S3).

Next, the green sheets are cut into predetermined shapes and are sintered (steps S4 and S5). Next, the laser irradiation is performed again to form one or more additional through-holes in the introducing hole forming layer 15 to obtain a desired output value (step S6) while measuring an output value of the gas sensing element 1. More specifically, formation of introducing hole (or holes) 150 is not only performed in the green condition of the sheet (or sheets) in the above-described step S2 but also performed in the sintered condition in the above-described step S6.

It is also possible to replace the above-described step S2 with a step (i.e. step S3-2) succeeding the step S3 to form the introducing hole (or holes) 150 before sintering the green sheets. Furthermore, it is also possible to perform both of the above-described steps S2 and S3-2. However, in the case of forming the introducing hole 150 in the step S3-2, it is necessary to prevent the green sheet of solid electrolytic substrate 11 from being damaged by the laser. Hence, in this case, it is preferable to fill a space of the measured gas chamber 23 with an appropriate organic protecting member which disappears in the sintering process.

Furthermore, the formation of introducing hole 150 for adjusting the output of gas sensing element 1 (step S6) can be performed prior to formation of the hole based an output value measured in advance, instead of measuring the output value of gas sensing element 1. Furthermore, the method for forming the introducing hole 150 for adjusting the output of gas sensing element 1 is similar to that of the fourth embodiment. Regarding the rest of arrangement, this embodiment is similar to the first embodiment.

According to this embodiment, one or more introducing holes 150 can be formed beforehand in a soft body of the introducing hole forming layer 15 because the introducing hole forming layer 15 is not yet hardened by the sintering operation. Thus, it becomes possible to form a required number of introducing holes 150 easily within a short time. Then, after finishing the sintering operation, the output value of the gas sensing element 1 is adjusted to form the introducing hole 150. It becomes possible to accurately obtain desired output characteristics. Accordingly, this embodiment can easily obtain a gas sensing element capable of accurately obtaining desired output characteristics. Regarding the rest of functions and effects, this embodiment is similar to the first embodiment.

### Seventh Embodiment

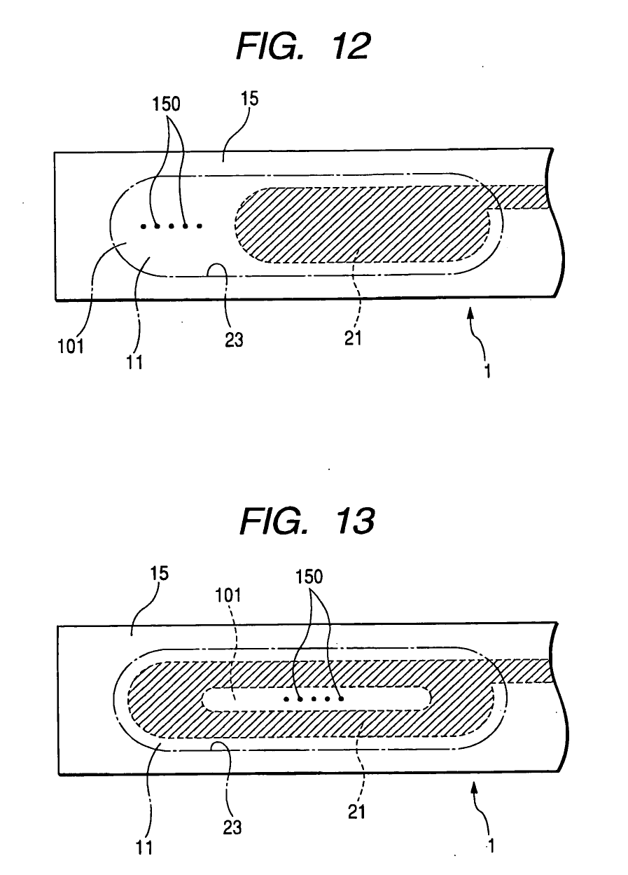

This embodiment is, as shown in FIGS. 12 and 13, characterized in that a projection of the measured gas chamber 23 on the surface of the solid electrolytic substrate 11 is present in an electrode non-forming region 101 where the measured gas side electrode 21 is not formed, and the introducing hole 150 formed in the introducing hole forming layer 15 is in the electrode non-forming region 101. For example, as shown in FIG. 12, the electrode non-forming region 101 can be formed at a distal end side of the measured gas side electrode 21. Furthermore, as shown in FIG. 13, the electrode non-forming region 101 can be formed inside an annular measured gas side electrode 21. Furthermore, according to this embodiment, plural introducing holes 150 are provided. Regarding the rest of arrangement, this embodiment is similar to the first embodiment.

According to this embodiment, the laser is not irradiated onto the measured gas side electrode 21 during the processing of forming the introducing holes 150. More specifically, immediately after each introducing hole 150 is opened as a result of laser irradiation applied onto the introducing hole forming layer 15, the laser directly hits the electrode non-forming region 101. No laser is irradiated onto the measured gas side electrode 21. Accordingly, no damage is given to the measured gas side electrode 21. Regarding the rest of functions and effects, this embodiment is similar to the first embodiment.

### Eighth Embodiment

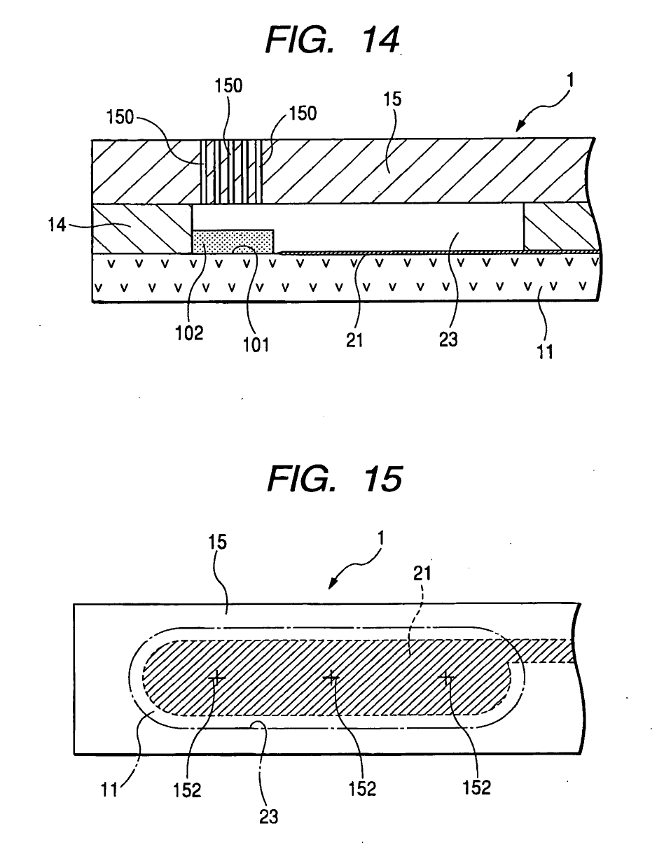

This embodiment is, as shown in FIG. 14, characterized in that a protecting member 102 protecting the solid electrolytic substrate 11 is disposed in the electrode non-forming region 101 of the measured gas chamber 23, and the introducing hole 150 is provided in a predetermined region of the introducing hole forming layer 15 wherein a projection of the protecting member 102 is formed. For example, the protecting member 102 is an aluminum porous body. Regarding the rest of arrangement, this embodiment is similar to the first embodiment.

According to this embodiment, it becomes possible to prevent the laser from irradiating onto the solid electrolytic substrate 11. Thus, the solid electrolytic substrate 11 is not damaged. Regarding the rest of functions and effects, this embodiment is similar to the first embodiment.

### Ninth Embodiment

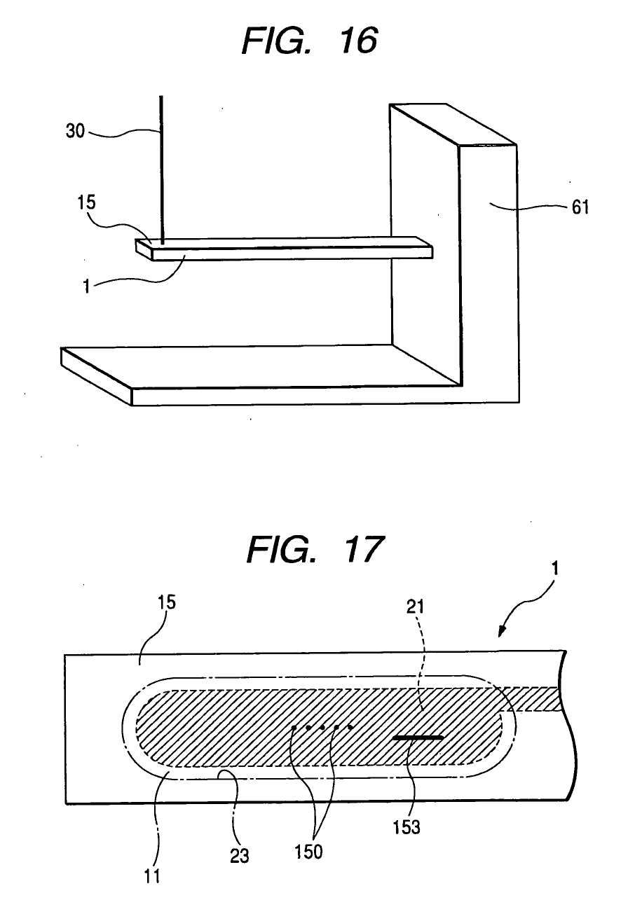

This embodiment is, as shown in FIGS. 15 and 16, characterized in that the process of performing laser irradiation includes an adjustment of a focal position of the laser 30 in accordance with optical displacement of a processing point caused by thermal effect of the gas sensing element 1.

More specifically, as shown in FIG. 15, a predetermined number of focus patterns 152 are formed on the surface of the introducing hole forming layer 15. Furthermore, as shown in FIG. 16, in the case that formation of the introducing hole is performed while measuring the output of gas sensing element 1, a proximal end of gas sensing element 1 is fixed to a holding jig 61 which is connected to a heater circuit and an A/F control circuit. Then, electric power is supplied to the heater 19 incorporated into the gas sensing element 1 (refer to FIGS. 1 and 2) to increase the temperature of gas sensing element 1. In this case, warpage or other thermal deformation may be slightly caused in the gas sensing element 1. Moreover, ambient air may optically cause fluctuations due to heat of gas sensing element 1. The refraction function being thus caused will optically induce deviation of the processing point.

Hence, at the end of this thermal deformation, a step of adjusting the focal position of laser 30 is performed by utilizing the patterns 152. Then, after the focal position adjustment is finished, the laser irradiation is performed to form the introducing holes 150. Regarding the rest of arrangement, this embodiment is similar to the first embodiment.

According to this embodiment, formation of accurate introducing holes 150 can be efficiently performed. More specifically, in the case of forming the introducing hole 150 while measuring the output of gas sensing element 1, the gas sensing element 1 is heated to have a high temperature. In this case, warpage or other thermal deformation may be slightly caused in the gas sensing element 1. More specifically, the warpage will be caused due to a difference in the thermal expansion coefficient between the solid electrolytic substrate 11 of zirconia ceramic and other layer of alumina ceramic. Ambient air may optically cause fluctuations due to heat of gas sensing element 1. The refraction function being thus caused will optically induce deviation of the processing point.

In this case, if the focal position is fixed during the laser irradiation processing, the condensing beam diameter at the processing position will become larger due to deviation of the focal point. Therefore, the formed introducing hole 150 tends to have a larger diameter. It will take a long time to form the introducing hole 150. Hence, adjusting the focal position of laser 30 immediately before performing the laser irradiation makes it possible to efficiently and accurately form the introducing hole 150, even if the gas sensing element 1 causes thermal deformation. Regarding the rest of functions and effects, this embodiment is similar to the first embodiment.

### Tenth Embodiment

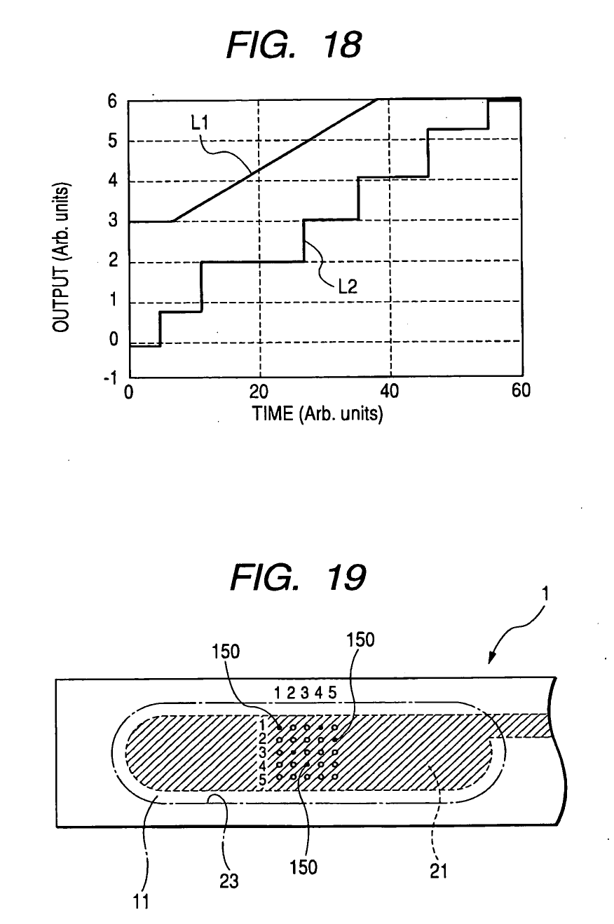

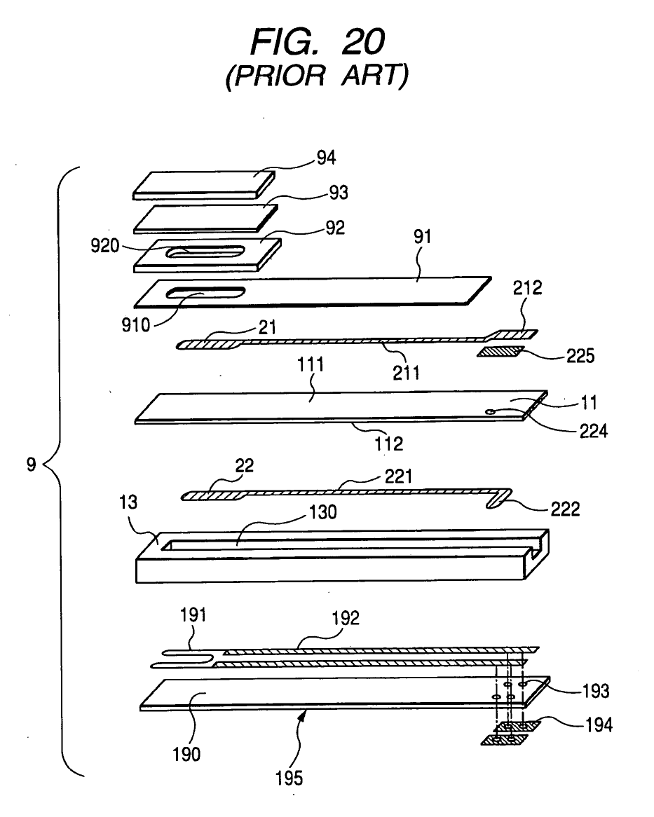

This embodiment is, as shown in FIGS. 17 and 18, characterized in that the laser irradiation is performed by shifting an irradiation position of the laser 30 relative to the introducing hole forming layer 15 while an output value of gas sensing element 1 is measured, so as to form an introducing hole 153 having an elongated shape, and the length of the introducing hole 153 is determined in accordance with the output value of gas sensing element 1. For example, as shown in FIG. 17, five introducing holes 150 are formed to have pinhole-like configuration. Then, the introducing hole 153 having an elongated shape is formed while the output value of gas sensing element 1 is measured. The length of elongated introducing hole 153 is gradually increased. In this case, as indicated by a curve L1 shown in FIG. 18, the output value of gas sensing element 1 gradually increases.

As the output value of gas sensing element 1 is measured in the air, an output value relative to the oxygen concentration in the air can be measured. Hence, at the time the measure value becomes a desired output value as an output value relative to the oxygen concentration in the air, the above-described processing for increasing the length of introducing hole 150 is stopped. Regarding detains of the method for forming the introducing hole 150 based on adjustment of the output, the above-described fourth embodiment can be referred to as a preferable example. Regarding the rest of arrangement, this embodiment is similar to the first embodiment.

According to this embodiment, fine adjustment of the output value of gas sensing element 1 can be easily performed. More specifically, in the case that the output value of gas sensing element 1 is adjusted by changing the total number of introducing holes 150 to be formed, the output value increases stepwise in response to increase in the number (i.e. in accordance with elapse of time required for opening the holes) as indicated by a curve L2 of FIG. 18. On the other hand, in the case that the output value of gas sensing element 1 is adjusted by increasing the length of elongated introducing hole 150, the output value increases continuously (or linearly) in response to increase in the length (i.e. in accordance with elapse of time required for opening the holes) as indicated by a curve L1 of FIG. 18. Accordingly, fine adjustment of the output value of gas sensing element 1 can be easily performed. Regarding the rest of functions and effects, this embodiment is similar to the first embodiment.

### Eleventh Embodiment

This embodiment is, as shown in FIG. 19, characterized in that forming positions of the introducing hole 150 are utilized to record identification information of the gas sensing element 1. More specifically, as shown in FIG. 19, forming positions of numerous introducing holes 150 are determined to form a matrix pattern of 5 lines×5 rows. According to this embodiment, it becomes possible to identify each sensing element by selectively forming the introducing holes 150 on this matrix pattern. For example, according to the gas sensing element 1 shown in FIG. 19, a total of five introducing holes 150 are positioned at the coordinates of (1,1), (2,3), (3,4), (4,1), and (5,2) of this matrix pattern. In this case, an identification number “3412” is assigned to this gas sensing element 1. According to this embodiment, the point (1, 1) is used as a reference point. Then, various characteristics of this gas sensing element 1 can be known by referring to this identification number. Although this embodiment uses a matrix pattern of 5 lines×5 rows, it is needless to say that other matrix patterns can be used considering the size of processing portion, accuracy of hole positions, and available region. Regarding the rest of arrangement, this embodiment is similar to the first embodiment.

According to this embodiment, the introducing holes 150 can express or represent identification information used for identifying output characteristics or other information relating to the gas sensing element 1. Regarding the rest of functions and effects, this embodiment is similar to the first embodiment.

1. A method for manufacturing a multilayered gas sensing element comprising a solid electrolytic substrate, a measured gas side electrode and a reference electrode provided on surfaces of said solid electrolytic substrate, a measured gas chamber in which said measured gas side electrode is provided, and an introducing hole forming layer with an introducing hole for introducing a measured gas from an ambient atmosphere into said measured gas chamber and also providing a diffusion resistance to said measured gas introduced into said measured gas chamber,
wherein said manufacturing method includes a step of forming said introducing hole by performing laser irradiation applied to said introducing hole forming layer.

2. The gas sensing element manufacturing method in accordance with claim 1, wherein a diameter of said introducing hole is in a range from 1 μm to 50 μm.

3. The gas sensing element manufacturing method in accordance with claim 1, wherein said introducing hole consists of a plurality of holes.

4. The gas sensing element manufacturing method in accordance with claim 3 wherein at least one of said plural introducing holes is formed before sintering said gas sensing element.

5. The gas sensing element manufacturing method in accordance with claim 1, wherein an output value of said gas sensing element is measured when said laser irradiation is performed, and diameter and number of said introducing hole is determined with reference to the output value of said gas sensing element.

6. The gas sensing element manufacturing method in accordance with claim 1, wherein said laser irradiation is performed by using a pulse oscillation laser.

7. The gas sensing element manufacturing method in accordance with claim 1, wherein a wavelength of said laser is equal to or less than 350 nm.

8. The gas sensing element manufacturing method in accordance with claim 7, wherein said laser irradiation is performed by using an excimer laser or a YAG laser using a third harmonic generator.

9. The gas sensing element manufacturing method in accordance with claim 1, wherein a pulse half-value width of said laser is equal to or less than 1 ps.

10. The gas sensing element manufacturing method in accordance with claim 9, wherein said laser irradiation is performed by using a titanium sapphire laser.

11. The gas sensing element manufacturing method in accordance with claim 1, wherein a focal position of said laser is changed with reference to progress in the process of forming an introducing hole by using said laser.

12. The gas sensing element manufacturing method in accordance with claim 1, wherein the laser processing applied to said introducing hole forming layer is controlled by optically observing an irradiation position of the laser irradiated on said introducing hole forming layer.

13. The gas sensing element manufacturing method in accordance with claim 1, wherein a projection of said measured gas chamber to the surface of said solid electrolytic substrate is present in an electrode non-forming region where said measured gas side electrode is not formed, and said introducing hole formed in said introducing hole forming layer is in said electrode non-forming region.

14. The gas sensing element manufacturing method in accordance with claim 13, wherein a protecting member protecting said solid electrolytic substrate is disposed in the electrode non-forming region of said measured gas chamber, and said introducing hole is provided in a predetermined region of said introducing hole forming layer wherein a projection of said protecting member is formed.

15. The gas sensing element manufacturing method in accordance with claim 1, wherein the process of performing said laser irradiation includes an adjustment of a focal position of said laser in accordance with optical displacement of a processing point caused by thermal effect of said gas sensing element.

16. The gas sensing element manufacturing method in accordance with claim 17, wherein the laser irradiation is performed by shifting an irradiation position of the laser relative to said introducing hole forming layer while an output value of said gas sensing element is measured, so as to form an elongated introducing hole, and the length of said elongated introducing hole is determined in accordance with the output value of said gas sensing element.

17. The gas sensing element manufacturing method in accordance with claim 1, wherein a forming position of said introducing hole represents identification information of said gas sensing element.

18. A gas sensing element comprising:
a solid electrolytic substrate,
a measured gas side electrode and a reference electrode provided on surfaces of said solid electrolytic substrate,
a measured gas chamber in which said measured gas side electrode is provided, and
an introducing hole forming layer with an introducing hole for introducing a measured gas from an ambient atmosphere into said measured gas chamber and also providing a diffusion resistance to said measured gas introduced into said measured gas chamber, wherein
said introducing hole is a through-hole formed by laser irradiation to have a diameter of 1 μm to 50 μm.

19. The gas sensing element in accordance with claim 18, wherein a projection of said measured gas chamber to the surface of said solid electrolytic substrate is present in an electrode non-forming region where said measured gas side electrode is not formed, and said introducing hole formed in said introducing hole forming layer is in said electrode non-forming region.

20. The gas sensing element in accordance with claim 19, wherein a protecting member protecting said solid electrolytic substrate is disposed in the electrode non-forming region of said measured gas chamber, and said introducing hole is provided in a predetermined region of said introducing hole forming layer wherein a projection of said protecting member is formed.

21. The gas sensing element in accordance with claim 18, wherein an introducing hole of said introducing hole forming layer has an elongated shape.

22. The gas sensing element in accordance with claim 18, wherein a forming position of said introducing hole represents identification information of said gas sensing element.
